(19) United States
(12) Patent Application Publication
(10) Pub. No.: US 2023/0246301 A1
(43) Pub. Date: Aug. 3, 2023

(54) LITHIUM-ION SECONDARY BATTERY

(71) Applicant: Prime Planet Energy & Solutions, Inc., Tokyo (JP)

(72) Inventors: Ryosuke IWATA, Kobe-shi (JP); Tomonori MAEDA, Kobe-shi (JP)

(21) Appl. No.: 17/988,772

(22) Filed: Nov. 17, 2022

(30) Foreign Application Priority Data
Feb. 2, 2022 (JP) 2022-014895

(51) Int. Cl. H01M 50/46; H01M 10/0525

(52) U.S. Cl. CPC H01M 50/461; H01M 10/0525

(57) ABSTRACT

An electrode body includes an overlapping part where a negative electrode sheet and a separator overlap each other in a thickness direction. The overlapping part includes an inside part located more inside than a peripheral part of the overlapping part when the overlapping part is seen in plan view in the thickness direction. The inside part satisfies the relationship, A>C and B>C, wherein A denotes interlayer separation strength between the separator and a negative electrode mixture layer, B denotes interlayer separation strength between the negative electrode mixture layer and a negative current collector foil, and C denotes intralayer separation strength of the negative electrode mixture layer.

### CROSS-REFERENCE TO RELATED APPLICATIONS

This application is based upon and claims the benefit of priority to Japanese Patent Application No. 2022-014895 filed on Feb. 2, 2022, the entire contents of which are incorporated herein by reference.

### BACKGROUND

### Technical Field

The present disclosure relates to a lithium-ion secondary battery.

### Related Art

WO 2014/081035 discloses an electrode body provided with a separator with an adhesive layer, which is formed of a porous polyolefin film having an adhesive layer on at least one surface, and an electrode including an electrode mixture layer containing an electrode active material and an electrode binder. This electrode body further includes an overlapping part, i.e., a bonded structure part, wherein the adhesive layer and the electrode mixture layer are laminated in contact relation and bonded to each other by thermocompression bonding.

Heretofore, there have been known a lithium-ion secondary battery provided with an electrode body including a positive electrode sheet having a positive electrode mixture layer on the surface of a positive current collecting foil, a negative electrode sheet having a negative electrode mixture layer on the surface of negative current collecting foil, and a separator interposed between the positive electrode sheet and the negative electrode sheet, and an electrolytic solution contained in the electrode body. In this lithium-ion secondary battery, the electrode body includes an overlapping part in which the negative electrode sheet and the separator are laminated in their thickness direction. The overlapping part is configured to satisfy the relationship of C>A, wherein A is the interlayer separation strength between the separator and the negative electrode mixture layer and C is the intralayer separation strength of the negative electrode mixture layer.

### SUMMARY

### Technical Problems

Meanwhile, the overlapping part includes an inside part that is located more inside than a peripheral part of the overlapping part when seen in plan view in the thickness direction. This inside part is more difficult for the gas generated therein to escape therefrom as compared with another part located outside the inside part. Thus, if gas is generated in a portion of the negative electrode sheet, falling within the inside part, which will be hereinafter referred to as a negative electrode inside part, the gas pressure in the inside part is apt to rise. However, for the lithium-ion secondary battery that satisfies the above relationship, C>A, when the gas pressure in the inside part rises due to the generation of gas in the negative electrode inside part, the separator and the negative electrode mixture layer are likely to separate from each other, generating gaps therebetween, resulting in accumulation of the gas in those gaps. Furthermore, Li could not enter in the negative electrode mixture layer adjacent to this gas accumulated space and thus Li may be deposited on the surface of the negative electrode mixture layer. This could reduce the durability and the safety of the lithium-ion secondary battery.

The present disclosure has been made to address the above problems and has a purpose to provide a lithium-ion secondary battery configured such that Li is less likely to be deposited on the surface of a negative electrode mixture layer.

### Means of Solving the Problems

To achieve the above-mentioned purpose, one aspect of the present disclosure provides a lithium-ion secondary battery comprising: an electrode body provided with: a positive electrode sheet including a positive current collecting foil and a positive electrode mixture layer provided on a surface of the positive current collecting foil; a negative electrode sheet including a negative current collecting foil and a negative electrode mixture layer provided on a surface of the negative current collecting foil; and a separator interposed between the positive electrode sheet and the negative electrode sheet; and an electrolytic solution contained in the electrode body, wherein the electrode body includes an overlapping part in which the negative electrode sheet and the separator overlap each other in their thickness direction, the overlapping part includes an inside part that is located more inside than a peripheral part of the overlapping part when the overlapping part is seen in plan view in the thickness direction, and the inside part satisfies a relationship, A>C and B>C, wherein A is interlayer separation strength between the separator and the negative electrode mixture layer, B is interlayer separation strength between the negative electrode mixture layer and the negative current collecting foil, and C is intralayer separation strength of the negative electrode mixture layer.

In the above-described lithium-ion secondary battery, the inside part of the overlapping part in which the negative electrode sheet and the separator overlap each other in their thickness direction meets both conditions, A>C and B>C. In the overlapping part, the inside part is located more inside than the peripheral part when the overlapping part is seen in the plan view in the thickness direction. This inside part is relatively difficult for the gas generated therein to escape therefrom.

In the foregoing lithium-ion secondary battery, the inside part of the overlapping part satisfies the relationship of A>C. Therefore, even if the gas pressure in the inside part rises due to the generation of gas in a part of the negative electrode included in the inside part, which is hereinafter referred to as a negative electrode inside part, the interlayer separation, or interfacial debonding, in which the separator and the negative electrode mixture layer separate, or debond, from each other, is less likely to occur than a conventional lithium-ion secondary battery that satisfies the relationship, C>A. Accordingly, the above-described lithium-ion secondary battery can avoid the generation of gas accumulation between the separator and the negative electrode mixture layer and further prevent Li deposition on the surface of the negative electrode mixture layer.

In the foregoing lithium-ion secondary battery, the inside part of the overlapping part further satisfies the relationship, B>C, so that the interlayer separation between the negative electrode mixture layer and the negative current collecting foil is also unlikely to occur, and thus gas accumulation is not likely to take place. In addition, the negative electrode mixture layer includes a number of voids, which allow the gas generated in the negative electrode mixture layer to be dispersed. Even though both the conditions A>C and B>C are satisfied, therefore, the intralayer separation of the negative electrode mixture layer by the gas, is not likely to occur. The lithium-ion secondary battery configured as above can achieve good durability and high safety. The gas generated in the inside part can eventually be discharged to the outside of the electrode body through the voids in the negative electrode mixture layer.

Further, in the foregoing lithium-ion secondary battery, the overlapping part may include an opposed part that faces the positive electrode mixture layer in the thickness direction when the overlapping part is seen in the plan view in the thickness direction, and the inside part may be configured to have a concentric similar shape to the opposed part and have an area equivalent to 50% of an area of the opposed part.

In the foregoing lithium-ion secondary battery, at least a part of the overlapping part, having a concentric similar shape to the opposed part that faces the positive electrode mixture layer in the thickness direction when the overlapping part is seen in the plan view from the thickness direction and having an area corresponding to 50% of the area of the opposed part, satisfies the relationship, both A>C and B>C. This configuration can prevent Li deposition on the surface of the negative electrode mixture layer, resulting in good durability and high safety of the lithium-ion secondary battery.

Further, in any one of the foregoing lithium-ion secondary batteries, the inside part may be configured such that the negative electrode sheet and the separator, both included within the inside part, are bonded to each other with an adhesive layer interposed between the negative electrode mixture layer of the negative electrode sheet and the separator.

Since the negative electrode mixture layer of the negative electrode sheet and the separator, which are included in the inside part, are mutually bonded with the adhesive layer interposed therebetween, the separator and the negative electrode mixture layer achieve high adhesion strength, i.e., high bonding strength, so that the interlayer separation between the separator and the negative electrode mixture layer is further less likely to occur. This configuration can further prevent Li deposition on the surface of the negative electrode mixture layer, resulting in further improved durability and safety of the lithium-ion secondary battery. The overlapping part in the lithium-ion secondary battery refers to the section where the negative electrode sheet and the separator overlap each other with the adhesive layer interposed therebetween in their thickness direction. For example, this overlapping part is the section where the negative electrode sheet and a separator with an adhesive layer coated on the surface of the separator, which will be referred to as an adhesive-layer-coated separator, overlap each other.

Further, in any one of the foregoing lithium-ion secondary batteries, the intralayer separation strength may be equal to or more than 1.0 N/m.

Since the intralayer separation strength C of the negative electrode mixture layer in the inside part is set to equal to or higher than 1.0 N/m, the intralayer separation of the negative electrode mixture layer is less likely to occur. Furthermore, the interlayer separation strength A between the separator and the negative electrode mixture layer and the interlayer separation strength B between the negative electrode mixture layer and the negative current collecting foil are larger than 1.0 N/m. Accordingly, this configuration is unlikely to accumulate gas between the separator and the negative electrode mixture layer and also between the negative electrode mixture layer and the negative current collecting foil, and additionally prevents Li deposition. The thus configured lithium-ion secondary battery can achieve good durability and high safety.

Furthermore, more preferably, the intralayer separation strength C is equal to or higher than 5.0 N/m. A preferred range of the interlayer separation strength A is 10.0 N/m or higher and a preferred range of the interlayer separation strength B is 6.0 N/m or higher. A preferred range of A—C, which is the difference between the interlayer separation strength A and the intralayer separation strength C, is 5.0 N/m or more and a preferred range of B—C, which is the difference between the interlayer separation strength B and the intralayer separation strength C, is 1.0 N/m or more.

Further, in any one of the foregoing lithium-ion secondary batteries, the lithium-ion secondary battery may have a volumetric energy density of 500 Wh/L or higher.

Since the volumetric energy density of the lithium-ion secondary battery is set to 500 Wh/L or higher, the lithium-ion secondary battery can provide good output characteristics. In the lithium-ion secondary battery, however, the higher the volumetric energy density is, the more gas is likely to be generated in the negative electrode sheet. When the volumetric energy density is 500 Wh/L or higher, the gas generation is especially apt to occur, leading to the interlayer separation as described above. In contrast, the above-described lithium-ion secondary battery is configured to satisfy the relationship, A>C and B>C, so that the foregoing interlayer separation is less likely to occur even when the volumetric energy density is 500 Wh/L or higher. The thus configured lithium-ion secondary battery prevents Li deposition on the negative electrode sheet and hence achieve good durability and high safety.

Further, in any one of the foregoing lithium-ion secondary batteries, the electrolytic solution may have a viscosity of 7.0 mPa·s or less.

In the lithium-ion secondary battery, the lower the viscosity of the electrolytic solution is, the more the gas is likely to be generated in the negative electrode sheet. When the viscosity of the electrolytic solution is equal to or less than 7.0 mPa·s, gas generation is particularly likely to occur in the negative electrode sheet, resulting in the interlayer separation. In the foregoing lithium-ion secondary battery configured to satisfy the relationship, A>C and B>C, as described above, the interlayer separation is less likely to occur even when the viscosity of the electrolytic solution is equal to or less than 7.0 mPa·s. Therefore, the lithium-ion secondary battery prevents Li deposition and thus achieve good durability and high safety.

Another aspect of the present disclosure provides a lithium-ion secondary battery comprising: an electrode body provided with: a positive electrode sheet including a positive current collecting foil and a positive electrode mixture layer provided on a surface of the positive current collecting foil; a negative electrode sheet including a negative current collecting foil and a negative electrode mixture layer provided on a surface of the negative current collecting foil; and a separator interposed between the positive electrode sheet and the negative electrode sheet; and an electrolytic solution contained in the electrode body, wherein the electrode body includes an overlapping part in which the negative electrode sheet and the separator overlap each other in their thickness direction, the overlapping part includes an inside part that is located more inside than a peripheral part of the overlapping part when the overlapping part is seen in plan view in the thickness direction, the inside part satisfies a relationship, A>C and B>C, wherein A is interlayer separation strength between the separator and the negative electrode mixture layer, B is interlayer separation strength between the negative electrode mixture layer and the negative current collecting foil, and C is intralayer separation strength of the negative electrode mixture layer, the overlapping part includes an opposed part that faces the positive electrode mixture layer in the thickness direction when the overlapping part is seen in the plan view in the thickness direction, the inside part is configured to have a concentric similar shape to the opposed part and have an area equivalent to 50% of an area of the opposed part, the inside part is configured such that the negative electrode sheet and the separator, both included within the inside part, are bonded to each other with an adhesive layer interposed between the negative electrode mixture layer of the negative electrode sheet and the separator, the intralayer separation strength is equal to or more than 1.0 N/m, the lithium-ion secondary battery has a volumetric energy density of 500 Wh/L or higher, and the electrolytic solution has a viscosity of 7.0 mPa·s or less.

### BRIEF DESCRIPTION OF THE DRAWINGS

FIG. 1 is a perspective view of a battery in an embodiment;

FIG. 2 is a plan view, i.e., a top view, of the battery;

FIG. 3 is a cross-sectional view taken along a J-J line in FIG. 2;

FIG. 4 is a cross-sectional view taken along a K-K line in FIG. 2;

FIG. 5 is a plan view of an electrode body in the embodiment;

FIG. 6 is a cross-sectional view taken along a D-D line in FIG. 5;

FIG. 7 is an enlarged view of a section E in FIG. 6;

FIG. 8 is a plan view of a positive electrode sheet in the embodiment;

FIG. 9 is a cross-sectional view taken along a line F-F in FIG. 8;

FIG. 10 is a plan view of a negative electrode sheet in the embodiment; and

FIG. 11 is a cross-sectional view taken along a line G-G in FIG. 10.

### DETAILED DESCRIPTION OF THE EXEMPLARY EMBODIMENTS

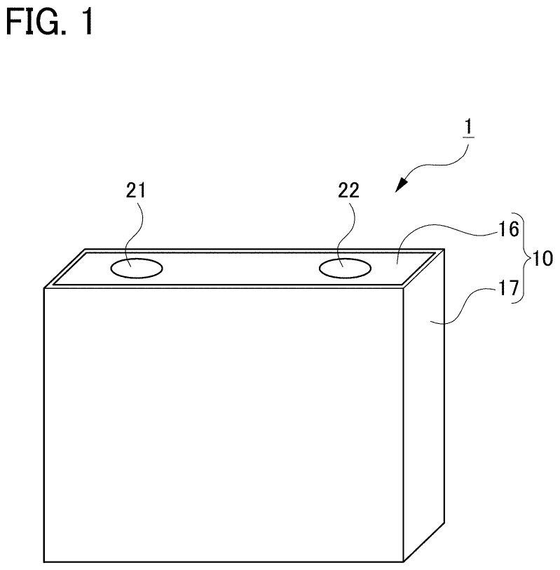

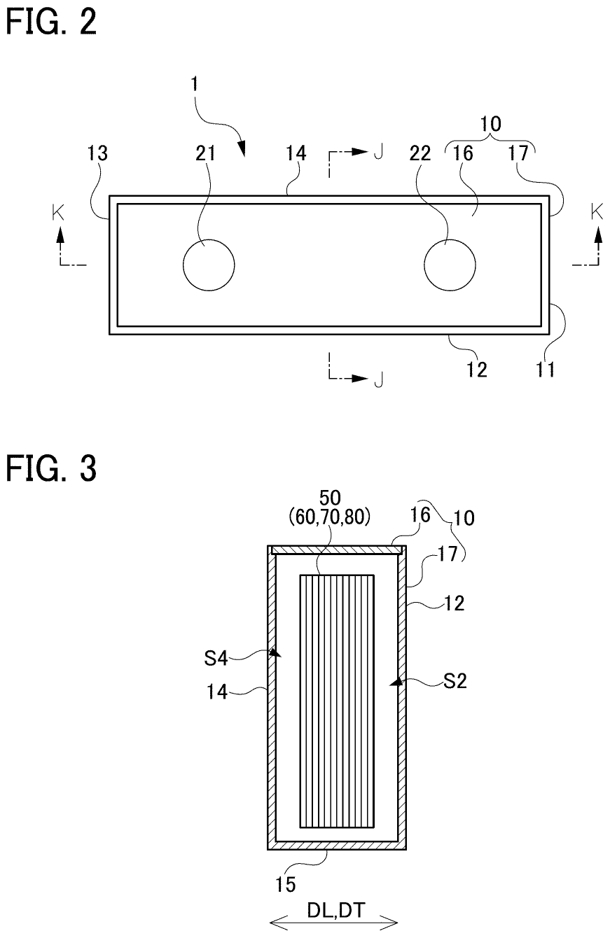

A detailed description of an embodiment of this disclosure will now be given referring to the accompanying drawings. A lithium-ion secondary battery 1 in the present embodiment is provided with an electrode body 50, a battery case 10 in which the electrode body 50 is housed, and columnar current collector terminals (i.e., a positive current collector terminal 21 and a negative current collector terminal 22) (see FIGS. 1 to 4). The electrode body 50 includes a positive electrode sheet 60, a negative electrode sheet 70, and a separator 80 coated with an adhesive layer, which will be hereinafter referred to as an adhesive-layer-coated separator 80, interposed between the positive electrode sheet 60 and the negative electrode sheet 70. To be concrete, the electrode body 50 is a lamination electrode body including a plurality of positive electrode sheets 60, a plurality of negative electrode sheets 70, and a plurality of adhesive-layer-coated separators 80, in which the positive electrode sheets 60 and the negative electrode sheets 70 are alternately laminated in a lamination direction DL with the adhesive-layer-coated separators 80 each interposed therebetween (see FIGS. 5 to 11). In the electrode body 50, an electrolytic solution not shown is contained.

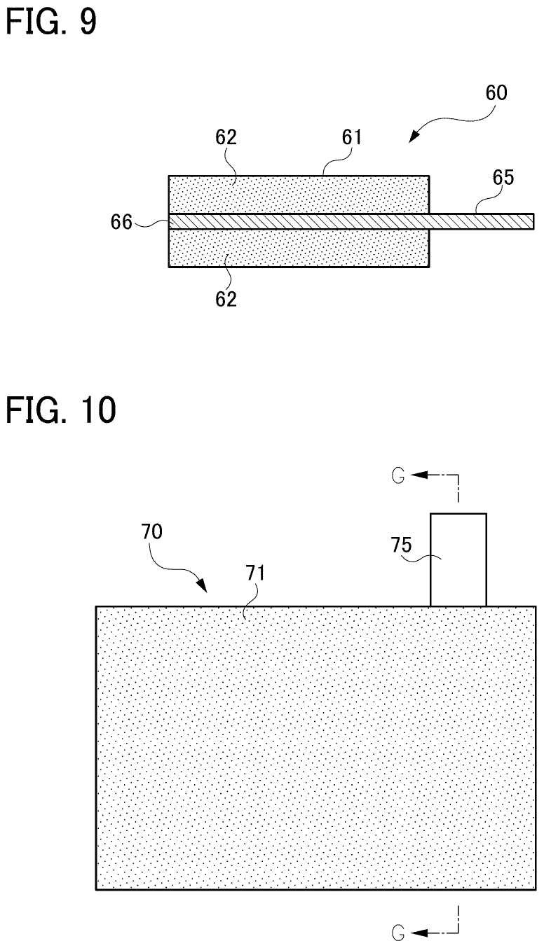

The positive electrode sheets 60 each include a positive current collecting foil 66 and a positive electrode mixture layer 62 provided on the positive current collecting foil 66. To be specific, each positive electrode sheet 60 includes a positive electrode mixture laminated part 61 having a rectangular plate shape, in which the positive electrode mixture layers 62 are individually laminated on each surface of the positive current collecting foil 66, and a positive current collector tab 65 that is formed from the positive current collecting foil 66 exposed without lamination of the positive electrode mixture layers 62 and extends from the positive electrode mixture laminated part 61 (see FIGS. 8 and 9). The positive electrode mixture layers 62 contain for example positive active material made of lithium transition metal composite oxide particles, conductive material made of carbon material, and a binder, and are bonded to the surfaces of the positive current collecting foil 66 with the binder.

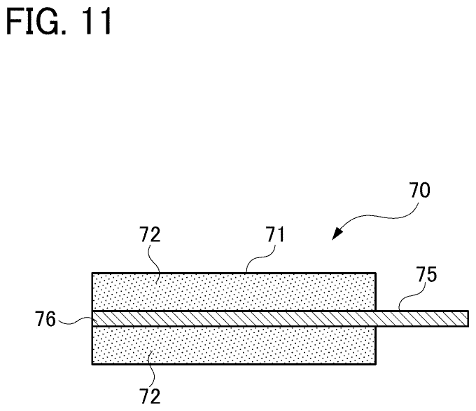

The negative electrode sheets 70 each include a negative electrode mixture layer 72 provided on the surface of the negative current collector foil 76. To be specific, each negative electrode sheet 70 includes a negative electrode mixture laminated part 71 having a rectangular plate shape, in which the negative electrode mixture layers 72 are individually laminated on each surface of the negative current collector foil 76, and a negative current collector tab 75 that is formed from the negative current collector foil 76 exposed without lamination of the negative electrode mixture layers 72 and extends from the negative electrode mixture laminated part 71 (see FIGS. 10 and 11). The negative electrode mixture layers 72 contain for example negative active material made of carbon material and a binder, and are bonded to the surfaces of the negative current collector foil 76 with the binder.

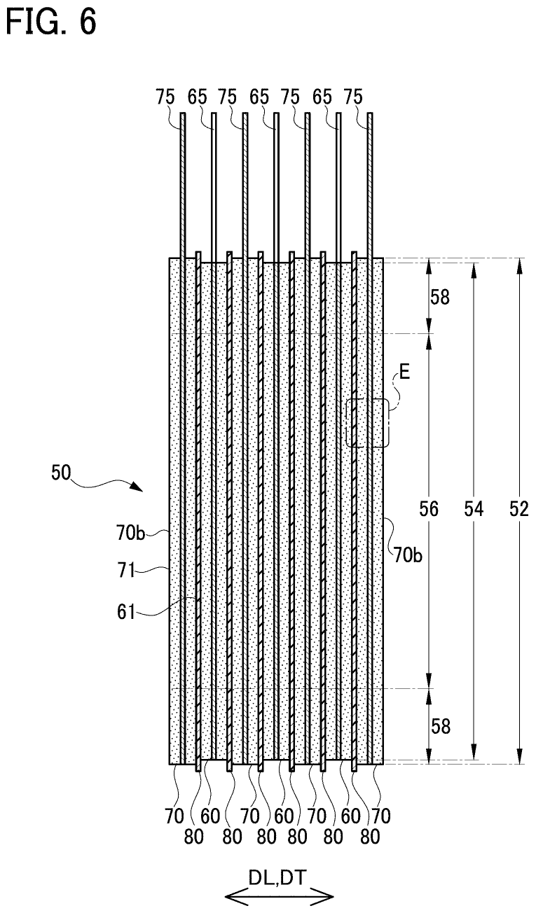

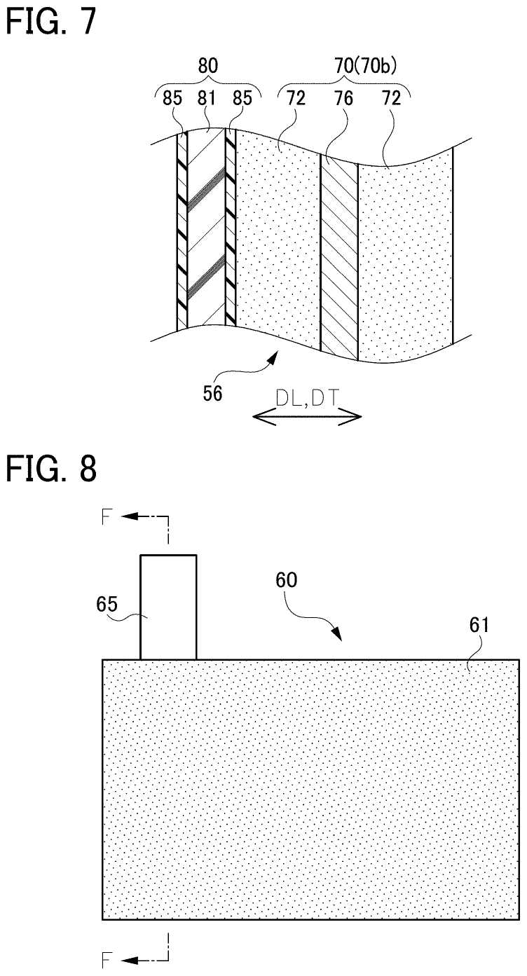

The adhesive-layer-coated separators 80 each include a separator 81 having a rectangular plate shape and adhesive layers 85 individually adhered to each surface, or both sides, of the separator 81 (see FIG. 7, which is an enlarged view of a section E in FIG. 6). The separators 81 may be formed of a porous sheet made of resin, such as polyolefin. As an alternative, the separators 81 also may be a separator including a heat insulating layer containing heat-resistant particles, such as ceramic particles, on the surface of a porous resin sheet made of for example polyolefin. The adhesive for forming the adhesive layers 85 may include for example an acrylic resin-based adhesive, a urethane resin-based adhesive, an ethylene-vinyl acetate resin-based adhesive, an epoxy resin-based adhesive, or a PVDF adhesive. As another alternative, the adhesive layers 85 may be a heat-resistant adhesive layer made of an adhesive mixed with heat-resistant particles. In this case, for example, the adhesive-layer-coated separators 80 each include the adhesive layers 85, i.e., heat-resistant adhesive layers, provided on the surfaces of the separators 81 formed of a porous resin sheet.

The battery case 10 is a hard case made of metal and has a rectangular parallelepiped box-like shape. This battery case 10 is provided with a case body 17 having a bottomed tubular shape with a rectangular cross-section, and a plate-shaped lid part 16 that closes the case body 17 (see FIGS. 1 to 4). The case body 17 includes a first side wall 11, a second side wall 12 continuous to the first side wall 11, a third side wall 13 continuous to the second side wall 12 and opposed to the first side wall 11, a fourth side wall 14 continuous to the third side wall 13 and opposed to the second side wall 12, and a bottom wall 15. The lid part 16 includes two through holes, from which the positive current collector terminal 21 and the negative current collector terminal 22 are individually exposed. The positive current collector terminal 21 is connected with the positive current collector tabs 65 by welding, while the negative current collector terminal 22 is connected with the negative current collector tabs 75 by welding. Further, cylindrical insulating members, not shown, are each interposed between the inner periphery of the through hole of the lid part 16 and the outer periphery of the positive current collector terminal 21 and between the inner periphery of the other through hole of the lid part 16 and the outer periphery of the negative current collector terminal 22. In FIG. 3, the negative current collector tabs 75 are not illustrated for convenience.

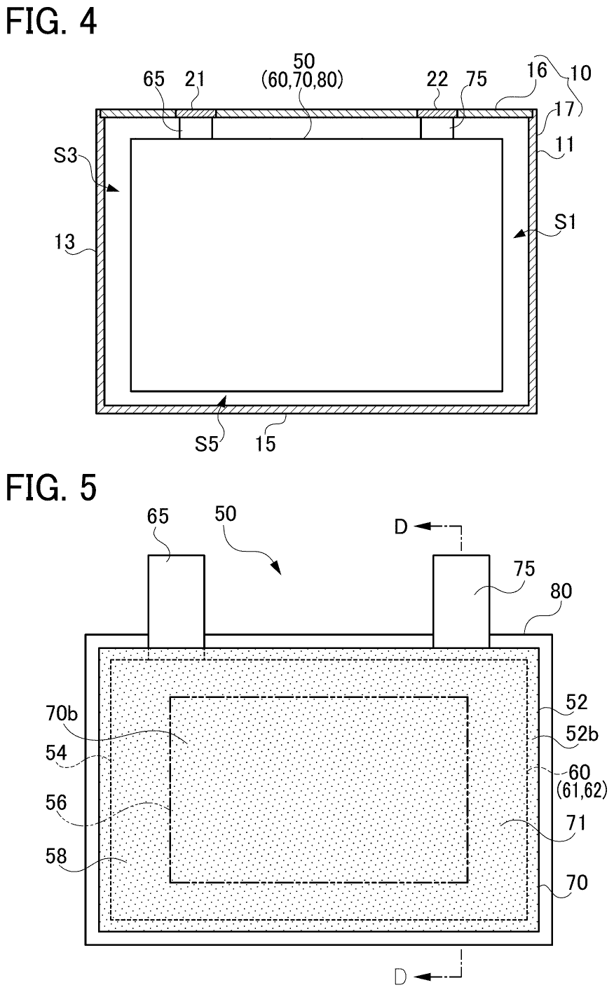

The electrode body 50 has a nearly rectangular parallelepiped shape and is housed in the battery case 10 so as to be spaced apart from the first side wall 11, the second side wall 12, the third side wall 13, the fourth side wall 14, and the bottom wall 15 of the battery case 10, with the spaces S1, S2, S3, S4, and S5 respectively formed therebetween (see FIGS. 3 and 4). FIGS. 3 and 4 show an initial state of battery use in which the electrode body 50 has not swollen, or expanded. In this lithium-ion secondary battery 1, accordingly, even when the lithium-ion secondary battery 1 is used with the battery case 10 not bound in the lamination direction DL of the electrode body 50 and then the electrode body 50 swells, or expands, in the lamination direction DL due to charging, deterioration (e.g., increased SEI), and other reasons, the presence of the spaces S2 and S4 between the electrode body 50 and the battery case 10 in the lamination direction DL can suppress the swollen electrode body 50 from pressing against the battery case 10 and hence prevent the battery case 10 from increasing in thickness, i.e., in the lamination direction DL.

To be specific, the dimensions of the spaces S2 and S4 are each defined as the dimension enough to avoid the electrode body 50 from generating a pressing force to press outward the second side wall 12 and the fourth side wall 14 of the battery case 10 even if the electrode body 50 swells in the lamination direction DL. Accordingly, the lithium-ion secondary battery 1 can be appropriately used without causing changes in dimension of the battery case 10 in the lamination direction DL even though the battery case 10 is not bound in the lamination direction DL of the electrode body 50.

Meanwhile, the electrode body 50 includes an overlapping part 52 in which the negative electrode sheets 70 and the separators 81 overlap one another in their thickness direction DT. Specifically, the overlapping part 52 refers to the section where the negative electrode sheets 70 and the adhesive-layer-coated separators 80 are laminated in the lamination direction DL corresponding to the thickness direction DT (see FIGS. 5 to 7). In FIG. 5, the overlapping part 52 is illustrated with dots, having the same range as the negative electrode mixture laminated part 71 in plan view. Herein, a part of the overlapping part 52, located more inside (i.e., on the center side) than a peripheral part 52b (a peripheral edge part) of the overlapping part 52 when the overlapping part 52 is seen in plan view in the thickness direction DT, that is, the lamination direction DL, is referred to as an inside part 56. This inside part 56 refers to the section of the overlapping part 52, located within the region enclosed by a two-dot chain line in FIG. 5.

Specifically, the overlapping part 52 includes an opposed part 54 that faces the positive electrode mixture layer 62 when the overlapping part 52 is seen in the plan view in the thickness direction DT, corresponding to a perpendicular direction to the drawing sheet of FIG. 5. The inside part 56 is configured to have a concentric similar shape (which is for example rectangular in the present embodiment) to the opposed part 54 and has the area corresponding to 50% of the area of the opposed part 54. The opposed part 54 is defined by a region enclosed with a broken line in FIG. 5, having the same range as the positive electrode mixture laminated part 61 when seen in plan view. In the overlapping part 53, the inside part 56 is relatively difficult for the gas generated therein to escape therefrom.

Meanwhile, in the lithium-ion secondary battery 1, when the electrolytic solution decomposes in the negative electrode sheet 70, gas is generated in the part of the negative electrode sheet 70 included in the overlapping part 52. However, the inside part 56 of the overlapping part 52 is less likely to release the gas generated therein as compared with the outside part 58 located more outside the inside part 56. Thus, if gas is generated in a site of the negative electrode sheet 70 included in the inside part 56, which is referred to as a negative electrode inside part 70b, the gas pressure in the inside part 56 tends to rise. In the conventional lithium-ion secondary battery, therefore, if the gas pressure in the negative electrode inside part rises due to gas generation in that inside part, the separator and the negative electrode mixture layer separate, or debond, from each other, that is, interlayer separation occurs between the separator and the negative electrode mixture layer, generating gaps therebetween, resulting in accumulation of the gas in those gaps. Furthermore, such a gas accumulated gap inhibits entrance of Li into the negative electrode mixture layer adjacent to this gap, and hence Li may be deposited on the surface of the negative electrode mixture layer. This may deteriorate the durability and the safety of the lithium-ion secondary battery.

In the present embodiment, in contrast, in at least the inside part 56 of the overlapping part 52, the negative electrode sheets 70 and the adhesive-layer-coated separators 80 are bonded to one another. In other words, in at least the inside part 56 of the overlapping part 52, the negative electrode sheets 70 and the separators 81 are bonded to one another with the adhesive layers 85 each interposed between the negative electrode mixture layer 72 of each negative electrode sheet 70 and each separator 81 (see FIG. 7). In the present embodiment, further, in the overlapping part 52, at least the inside part 56 satisfies the relationship, A>C and B>C, wherein A denotes the interlayer separation strength between the separator 81 (the adhesive-layer-coated separator 80) and the negative electrode mixture layer 72, B denotes the interlayer separation strength between the negative electrode mixture layer 72 and the negative current collector foil 76, and C denotes the intralayer separation strength, i.e., the layer fracture strength, of the negative electrode mixture layer 72.

In the lithium-ion secondary battery 1 in the present embodiment, the inside part 56 satisfies the relationship of A>C. Even if the gas pressure in the inside part 56 rises due to the generation of gas in the inside part 56, accordingly, the separators 81 and the negative electrode mixture layers 72 are less likely to separate, or peel off, from each other, as compared with the lithium-ion secondary battery satisfying the relationship, C>A. Thus, gas accumulation is less likely to occur between the separators 81 and the negative electrode mixture layers 72, and hence Li deposition on the surfaces of the negative electrode mixture layers 72 is less likely to occur.

In the lithium-ion secondary battery 1, the inside part 56 additionally satisfies the relationship, B>C. This configuration does not cause interlayer separation even between the negative electrode mixture layers 72 and the negative current collector foils 76, and thus gas accumulation is less likely to occur. Since a number of voids exist in each negative electrode mixture layer 72, the gas generated in those mixture layers 72 can be dispersed. From this respect, even though the relationship, both A>C and B>C, is satisfied, the intralayer separation, in which the negative electrode mixture layer 72 is internally fractured by gas, is less likely to occur. The thus configured lithium-ion secondary battery 1 can achieve good durability and high safety. The gas generated in the inside part 56 is eventually discharged to the outside of the electrode body 50 through the voids in the negative electrode mixture layers 72.

In the present embodiment, the intralayer separation strength C of each negative electrode mixture layer 72 in the inside part 56 is set to 1.0 N/m or more. This prevents the negative electrode mixture layers 72 from causing the intralayer separation. From the satisfied relationship, A>C and B>C, it is further understood that the interlayer separation strength A between the separators 81 and the negative electrode mixture layers 72 and the interlayer separation strength B between the negative electrode mixture layers 72 and the negative current collector foils 76 are larger than 1.0 N/m. Accordingly, gas accumulation is less likely to occur between the separators 81 and the negative electrode mixture layers 72 and between the negative electrode mixture layers 72 and the negative current collector foils 76, and further Li deposition is more unlikely to occur. The thus configured lithium-ion secondary battery 1 can achieve good durability and high safety.

In the present embodiment, the volumetric energy density of the lithium-ion secondary battery 1 set to 500 Wh/L or higher. Thus, the lithium-ion secondary battery 1 can provide adequate output characteristics. In lithium-ion secondary batteries, however, the higher the volumetric energy density is, the more gas is likely to be generated in the negative electrode sheets. When the volumetric energy density is 500 Wh/L or more, gas generation is especially apt to occur in the negative electrode sheets, leading to the interlayer separation. In contrast, the lithium-ion secondary battery 1 in the present embodiment satisfies the above-mentioned relationship, A>C and B>C, so that the interlayer separation is less likely to occur even when the volumetric energy density is 500 Wh/L or more. This configuration prevents Li deposition on the negative electrode sheets 70 and hence achieve good durability and high safety.

In the present embodiment, the viscosity of the electrolytic solution is set equal to or less than 7.0 mPa·s. In lithium-ion secondary batteries, however, the lower the viscosity of the electrolytic solution is, the more gas is likely to be generated in the negative electrode sheets. When the viscosity of the electrolytic solution is 7.0 mPa·s or less, gas generation is especially apt to occur in the negative electrode sheets, leading to the intralayer separation. In contrast, the lithium-ion secondary battery 1 in the present embodiment satisfies the relationship, A>C and B>C, so that the interlayer separation is less likely to occur even when the viscosity of the electrolytic solution is 7.0 mPa·s or less. This configuration prevents Li deposition on the negative electrode sheets 70 and hence achieve good durability and high safety.

### Examples 1 to 5

In each of lithium-ion secondary batteries 1 in Examples 1 to 5, of the overlapping part 52, the part satisfying the relationship, A>C and B>C has a concentric similar shape to the opposed part 54 when the overlapping part 52 is seen in plan view in the thickness direction DT. However, the overlapping parts 52 in Examples 1 to 5 have different bonding ranges where the negative electrode sheets 70 and the separators 81 are bonded to one another through the adhesive layers 85, so that the parts satisfying the relationship, A>C and B>C, have different area ratios to the opposed parts 54 in the plan view. In each of Examples 1 to 5, the bonding part of the overlapping part 52, where the negative electrode sheets 70 and the separators 81 are bonded to one another through the adhesive layers 85 satisfies the relationship, A>C and B>C.

The area ratio in Example 1 is 80%, the area ratio in Example 2 is 70%, the area ratios in Examples 3 and 4 are 60%, and the area ratio in Example 5 is 50%. In Example 5, therefore, in the overlapping part 52, only the inside part 56 satisfies the relationship, A>C and B>C. In each of Examples 1 to 4, in the overlapping part 52, the range including not only the inside part 56 but also a part of the outside part 58 satisfies the relationship, A>C and B>C. In Example 4, furthermore, compared with other examples, the content percentage of the binder in the negative electrode mixture layer 72 is small to decrease the intralayer separation strength C of the negative electrode mixture layer 72. In Examples 1 to 5, moreover, each adhesive-layer-coated separator 80 includes a separator 81 formed of a porous resin sheet, such as polyolefin, and adhesive layers 85 made of an acrylic resin-based adhesive adhesively provided on each surface, or both sides, of each separator 81.

### Comparative Example 1

A lithium-ion secondary battery prepared in Comparative example 1 is similar to the lithium-ion secondary battery in Example 1 excepting that the area ratio is 0%. Specifically, in the lithium-ion secondary battery in Comparative example 1, the negative electrode sheets 70 and the separators 81 are not bonded through the adhesive layers 85 and the relationship C>A is satisfied over the entire overlapping part 52 including the inside part 56.

### Peel Strength Test

A known 90°-peel strength test was implemented on the inside part 56 of the overlapping part 52 in each of Examples 1 to 5, i.e., an assembly composed of the negative electrode sheets 70 and the separators 81 bonded to one another through the adhesive layers 85 each interposed between the negative electrode mixture layers 72 and the separators 81. This test was executed pursuant to JIS K6854-1:1999 (ISO 8510-1:199 0). In Examples 1 to 5, consequently, the intralayer separation (i.e., intralayer fracture) of the negative electrode mixture layers 72 was observed. These results reveal that the inside parts 56 in Examples 1 to 5 each satisfy the relationship, A>C and B>C. The intralayer separation strength C in Examples 1 to 3 and 5 is 5.5 N/m, whereas the intralayer separation strength C in Example 4 is 1.0 M/m. For Comparative example 1, which clearly satisfies the relationship, C>A, the peel test was not performed. The above-mentioned results are shown in Table 1.

TABLE 1

| | Area ratio | | | | |
|---|---|---|---|---|---|
| | under A > | | Separation | Capacity | |
| | C and | | strength | maintenance | Li |
| | B > C | Peel test | C (N/m) | rate | deposition |
| Example 1 | 80% | Intralayer | 5.5 | 91% | Not |
| | | separation | | | observed |
| | | observed | | | |
| Example 2 | 70% | Intralayer | 5.5 | 91% | Not |
| | | separation | | | observed |
| | | observed | | | |
| Example 3 | 60% | Intralayer | 5.5 | 91% | Not |
| | | separation | | | observed |
| | | observed | | | |
| Example 4 | 60% | Intralayer | 1.0 | 91% | Not |
| | | separation | | | observed |
| | | observed | | | |
| Example 5 | 50% | Intralayer | 5.5 | 85% | Slightly |
| | | separation | | | observed |
| | | observed | | | |
| Compar- | 0% | — | — | 75% | Observed |
| ative | | | | | |
| Example 1 | | | | | |

### Durability Test

A durability test was implemented by a cycle charge-discharge test on the lithium-ion secondary batteries in Examples 1 to 5 and Comparative example 1. Specifically, each lithium-ion secondary battery was subjected to 200 charge-discharge cycles in each of which a battery was charged from 0% to 100% SOC and then discharged from 100% to 0% SOC under a temperature environment of 60° C. In this test, the discharge electricity in the 1^{st} charge-discharge cycle, which is the amount of electricity discharged from 100% SOC to 0% SOC, was measured as the initial-stage battery capacity, and the discharge electricity in the 200^{th} charge-discharge cycle, which is the amount of electricity discharged from 100% SOC to 0% SOC, was measured as the terminal-stage battery capacity. The ratio of the terminal-stage battery capacity to the initial-stage battery capacity is calculated as a capacity maintenance rate (%). Further, each lithium-ion secondary battery after subjected to the cycle charge-discharge test was disassembled to investigate whether Li has been deposited on the surface of the negative electrode mixture layers. Those results are shown in Table 1.

As shown in Table 1, the lithium-ion secondary battery in Comparative example 1 has a capacity maintenance rate of 75%. In contrast, the lithium-ion secondary batteries 1 in Examples 1 to 5 have a capacity maintenance rate of 85% or higher, exhibiting good durability. In particular, the lithium-ion secondary batteries 1 in Examples 1 to 4 exhibit excellent durability with a capacity maintenance rate of 91%. In the lithium-ion secondary battery in Comparative example 1, Li deposition was observed on the surfaces of the negative electrode mixture layers. In contrast, in the lithium-ion secondary batteries 1 in Examples 1 to 4, Li deposition was not observed on the surfaces of the negative electrode mixture layers. In the lithium-ion secondary battery 1 in Example 5, Li deposition was observed on the surfaces of the negative electrode mixture layers, but the deposition amount is significantly smaller than that in Comparative example 1.

From the above results, the lithium-ion secondary batteries 1 in Examples 1 to 5 are each considered to be a lithium-ion secondary battery capable of preventing Li deposition on the negative electrode sheets 70 (i.e., on the surfaces of the negative electrode mixture layers 72) and achieving good durability and high safety. This is because the lithium-ion secondary batteries 1 in Examples 1 to 5 each include the inside part 56 meeting both A>C and B>C.

The present disclosure is described in the foregoing embodiment, but is not limited thereto. The present disclosure may be embodied in other specific forms without departing from the essential characteristics thereof.

For instance, the foregoing embodiment exemplifies the lithium-ion secondary battery 1 provided with the electrode body 50 that is a lamination electrode body including the positive electrode sheets 60, the negative electrode sheets 70, and the separators 81, which have a flat plate shape and are laminated in the thickness direction DT. As an alternative, the present disclosure is also applicable to a lithium-ion secondary battery provided with a wound electrode body in which a positive electrode sheet, a negative electrode sheet, and a separator are laminated in the thickness direction DT and wound together.

### REFERENCE SIGNS LIST

1 Lithium-ion secondary battery
10 Battery case
50 Electrode body
52 Overlapping part
54 Opposed part
56 Inside part
60 Positive electrode sheet
62 Positive electrode mixture layer
66 Positive current collector foil
70 Negative electrode sheet
72 Negative electrode mixture layer
76 Negative current collector foil
80 Adhesive-layer-coated separator
81 Separator
85 Adhesive layer
DT Thickness direction
DL Lamination direction

What is claimed is:

1. A lithium-ion secondary battery comprising:
an electrode body provided with:
a positive electrode sheet including a positive current collecting foil and a positive electrode mixture layer provided on a surface of the positive current collecting foil;
a negative electrode sheet including a negative current collecting foil and a negative electrode mixture layer provided on a surface of the negative current collecting foil; and
a separator interposed between the positive electrode sheet and the negative electrode sheet; and
an electrolytic solution contained in the electrode body,
wherein the electrode body includes an overlapping part in which the negative electrode sheet and the separator overlap each other in their thickness direction,
the overlapping part includes an inside part that is located more inside than a peripheral part of the overlapping part when the overlapping part is seen in plan view in the thickness direction, and
the inside part satisfies a relationship, A>C and B>C, wherein A is interlayer separation strength between the separator and the negative electrode mixture layer, B is interlayer separation strength between the negative electrode mixture layer and the negative current collecting foil, and C is intralayer separation strength of the negative electrode mixture layer.

2. The lithium-ion secondary battery according to claim 1, wherein
the overlapping part includes an opposed part that faces the positive electrode mixture layer in the thickness direction when the overlapping part is seen in the plan view in the thickness direction, and
the inside part is configured to have a concentric similar shape to the opposed part and have an area equivalent to 50% of an area of the opposed part.

3. The lithium-ion secondary battery according to claim 1, wherein the inside part is configured such that the negative electrode sheet and the separator, both included within the inside part, are bonded to each other with an adhesive layer interposed between the negative electrode mixture layer of the negative electrode sheet and the separator.

4. The lithium-ion secondary battery according to claim 2, wherein the inside part is configured such that the negative electrode sheet and the separator, both included within the inside part, are bonded to each other with an adhesive layer interposed between the negative electrode mixture layer of the negative electrode sheet and the separator.

5. The lithium-ion secondary battery according to claim 1, wherein the intralayer separation strength is equal to or more than 1.0 N/m.

6. The lithium-ion secondary battery according to claim 2, wherein the intralayer separation strength is equal to or more than 1.0 N/m.

7. The lithium-ion secondary battery according to claim 3, wherein the intralayer separation strength is equal to or more than 1.0 N/m.

8. The lithium-ion secondary battery according to claim 4, wherein the intralayer separation strength is equal to or more than 1.0 N/m.

9. The lithium-ion secondary battery according to claim 1, wherein the lithium-ion secondary battery has a volumetric energy density of 500 Wh/L or higher.

10. The lithium-ion secondary battery according to claim 2, wherein the lithium-ion secondary battery has a volumetric energy density of 500 Wh/L or higher.

11. The lithium-ion secondary battery according to claim 1, wherein the electrolytic solution has a viscosity of 7.0 mPa·s or less.

12. The lithium-ion secondary battery according to claim 2, wherein the electrolytic solution has a viscosity of 7.0 mPa·s or less.

13. A lithium-ion secondary battery comprising:
an electrode body provided with:
a positive electrode sheet including a positive current collecting foil and a positive electrode mixture layer provided on a surface of the positive current collecting foil;
a negative electrode sheet including a negative current collecting foil and a negative electrode mixture layer provided on a surface of the negative current collecting foil; and
a separator interposed between the positive electrode sheet and the negative electrode sheet; and
an electrolytic solution contained in the electrode body,
wherein the electrode body includes an overlapping part in which the negative electrode sheet and the separator overlap each other in their thickness direction,
the overlapping part includes an inside part that is located more inside than a peripheral part of the overlapping part when the overlapping part is seen in plan view in the thickness direction,
the inside part satisfies a relationship, A>C and B>C, wherein A is interlayer separation strength between the separator and the negative electrode mixture layer, B is interlayer separation strength between the negative electrode mixture layer and the negative current collecting foil, and C is intralayer separation strength of the negative electrode mixture layer,
the overlapping part includes an opposed part that faces the positive electrode mixture layer in the thickness direction when the overlapping part is seen in the plan view in the thickness direction,
the inside part is configured to have a concentric similar shape to the opposed part and have an area equivalent to 50% of an area of the opposed part,
the inside part is configured such that the negative electrode sheet and the separator, both included within the inside part, are bonded to each other with an adhesive layer interposed between the negative electrode mixture layer of the negative electrode sheet and the separator,
the intralayer separation strength is equal to or more than 1.0 N/m,
the lithium-ion secondary battery has a volumetric energy density of 500 Wh/L or higher, and
the electrolytic solution has a viscosity of 7.0 mPa·s or less.
